(19) United States
(12) Patent Application Publication
(10) Pub. No.: US 2025/0242712 A1
(43) Pub. Date: Jul. 31, 2025

(54) CHARGE NOTIFICATION SERVER

(71) Applicant: TOYOTA JIDOSHA KABUSHIKI KAISHA, Toyota-shi (JP)

(72) Inventor: Fumichika YAMAGUCHI, Nagoya-shi (JP)

(73) Assignee: TOYOTA JIDOSHA KABUSHIKI KAISHA, Toyota-shi (JP)

(21) Appl. No.: 18/961,482

(22) Filed: Nov. 27, 2024

(30) Foreign Application Priority Data
Jan. 31, 2024 (JP) 2024-012763

(51) Int. Cl. B60L 53/68; B60L 53/62; B60L 53/66

(52) U.S. Cl. CPC B60L 53/68; B60L 53/62; B60L 53/66

(57) ABSTRACT

A charge notification server for notifying a battery mounted on a vehicle, the charge notification server including: a first receiving unit that receives, from the vehicle, either one of first vehicle data including a battery SOC that is a battery storage rate or second vehicle data that does not include a battery SOC; a second receiving unit that, when the first receiving unit receives the second vehicle data, receives information on a state of charge of the battery from an external device connected to the vehicle; a conversion unit that converts information on a state of charge of the battery into a battery SOC; a determination unit that determines whether or not charging of the battery is necessary based on the battery SOC; and a transmission unit that, when it is determined that charging of the battery is necessary, transmits a charging request of the battery.

### CROSS-REFERENCE TO RELATED APPLICATION

This application claims priority to Japanese Patent Application No. 2024-012763 filed on Jan. 31, 2024, incorporated herein by reference in its entirety.

### BACKGROUND

### 1. Technical Field

The present disclosure relates to a server etc. that makes a notification about a battery mounted on a vehicle.

### 2. Description of Related Art

Journal of Technical Disclosure of the Japan Institute of Disclosure and Innovation (JIII) No. 2023-500561 discloses a system that suppresses non-execution of charging by making a notification of the timing of supplementary charging for each vehicle in stock at a vehicle dealer. In this system, a server receives vehicle data including the state of a battery acquired by a battery sensor mounted on a vehicle, and the server determines whether it is necessary to charge the battery based on the vehicle data and determines that charging is necessary. In this case, the server sends a request to charge the battery to a vehicle dealer having the vehicle in stock.

### SUMMARY

In the system described in Journal of Technical Disclosure of JIII No. 2023-500561, the server cannot receive vehicle data including the state of a battery from a vehicle not equipped with a battery sensor. Therefore, the server cannot determine whether it is necessary to charge the battery for a vehicle not equipped with a battery sensor, and thus cannot make a necessary notification.

Here, it is conceivable to manage the battery of a vehicle not equipped with a battery sensor using a management system different from the management system for a vehicle equipped with a battery sensor. In this case, however, batteries of a plurality of vehicles must be managed using a plurality of management systems, and there is an issue that vehicle dealers etc. have trouble in managing vehicles or grasping information on the vehicles.

The present disclosure has been made in view of the above issue, and an object of the present disclosure is to provide a charge notification server capable of determining whether it is necessary to charge a battery and making a notification for a plurality of vehicles, irrespective of whether a battery sensor is mounted.

In order to address the above issue, an aspect of the present disclosure provides a charge notification server that makes a notification about a battery mounted on a vehicle, including:
a first receiving unit that receives, from the vehicle, either one of first vehicle data including a battery state of charge as a power storage rate of the battery and second vehicle data not including the battery state of charge;
a second receiving unit that receives information about a charge state of the battery from an external device connected to the vehicle when the first receiving unit receives the second vehicle data;
a conversion unit that converts information about a charge state of the battery into the battery state of charge;
a determination unit that determines whether the battery needs to be charged based on the battery state of charge; and
a transmission unit that transmits a request to charge the battery when the determination unit determines that the battery needs to be charged.

The charge notification server according to the present disclosure has a function of converting information about the charge state of a battery into a battery state of charge. Therefore, it is possible to determine whether it is necessary to charge a battery and make a necessary notification for a plurality of vehicles, irrespective of whether a battery sensor is mounted.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a vehicle management system including a charge notification server according to the present embodiment;

FIG. 2 is a flow chart which describes the processing which vehicles perform;

FIG. 3 is a flow chart which describes the processing which a measuring instrument performs;

FIG. 4 is a flow chart which describes the processing which a charge notification server performs; and

FIG. 5 is a flow chart which describes the processing which a vehicles store performs.

### DETAILED DESCRIPTION OF EMBODIMENTS

The charge notification server acquires battery information that can be measured by a measuring instrument externally connected to the sensor-non-mounted vehicle, for a sensor-non-mounted vehicle in which the storage rate (SOC) of the battery cannot be measured by the sensor, and determines whether or not the battery needs to be charged based on SOC of the battery derived from the battery information. Thus, both the sensor-mounted vehicle and the sensor-non-mounted vehicle can be notified of charging by the same vehicle management system.

Hereinafter, an embodiment of the present disclosure will be described in detail with reference to the drawings.

### Embodiment

### Configuration

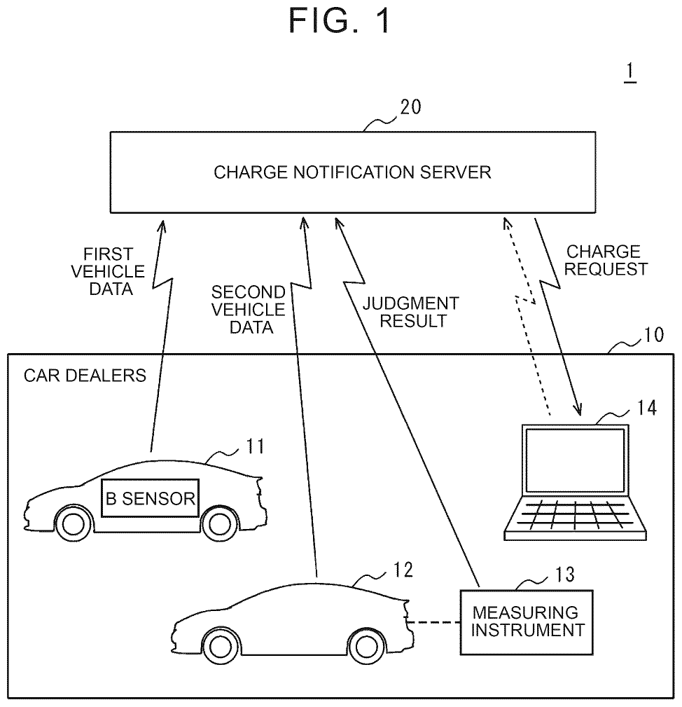

FIG. 1 is a diagram illustrating a schematic configuration of a vehicle management system 1 including a charge notification server 20 according to an embodiment of the present disclosure. The vehicle management system 1 illustrated in FIG. 1 has a configuration in which a vehicle dealer 10 and a charge notification server 20 are communicably connected via a network. The number of vehicle dealers 10 constituting the vehicle management system 1 is not limited to one, and may be a plurality.

The vehicle dealer 10 is a store such as a dealer having a storage vehicle such as an inventory vehicle before sale or a vehicle before delivery. The storage vehicle included in the vehicle dealer 10 is divided into a “sensor-mounted vehicle 11” which is a vehicle equipped with a battery sensor (B sensor) capable of acquiring a state of an in-vehicle battery (not shown), and a “sensor-non-mounted vehicle 12” which is a vehicle not equipped with the battery sensor. The stored vehicles of the vehicle dealer 10 are recognized and managed in advance by the charge notification server 20 using unique identification information (VIN or the like) assigned to each vehicle.

The sensor-mounted vehicle 11 and the sensor-non-mounted vehicle 12 each include a communication function unit (such as a DCM) capable of transmitting various data (hereinafter, referred to as “vehicle data”) related to the vehicle to the charge notification server 20. Vehicle data (first vehicle data) transmitted by the sensor-mounted vehicle 11 to the charge notification server 20 includes at least a power storage rate of the vehicle-mounted battery (hereinafter referred to as “battery SOC”), an integrated value (hereinafter referred to as “dark current integrated value”) of a current flowing out from the vehicle-mounted battery during a period (during parking) in which the vehicle is stored in the vehicle dealer 10, and a number of days (hereinafter referred to as “parking days”) in which the vehicle is stored in the vehicle dealer 10. In addition, the vehicle data (second vehicle data) transmitted by the sensor-non-mounted vehicle 12 to the charge notification server 20 does not include the battery SOC or the dark current integrated value that can be acquired by the battery sensor, and includes at least the number of parking days. These vehicle data (first and second) are transmitted to the charge notification server 20 in association with the identification information unique to the vehicle when the ignition switch of the storage vehicle is turned on (IG-ON) by, for example, a worker of the vehicle dealer 10. In order to accurately manage the state of the in-vehicle battery, it is desirable to transmit the vehicle data to the charge notification server 20 periodically (for example, every several days or weeks).

Further, the vehicle dealer 10 has a measuring instrument 13 connectable to the sensor-non-mounted vehicle 12. The measuring instrument 13 is an external device (such as a battery tester) that is connected to the sensor-non-mounted vehicle 12 by a worker or the like of the vehicle dealer 10 and can perform measurement (health check or the like) of information regarding the state of the vehicle-mounted battery. The measuring instrument 13 measures the voltage and the current of the in-vehicle battery as information on the state of the in-vehicle battery, and determines whether the state of charge of the in-vehicle battery is good or bad based on the measured value and a predetermined determination condition. Further, the measuring instrument 13 includes a communication function unit that communicates with the charge notification server 20, and can transmit the determination result regarding the state of charge of the in-vehicle battery to the charge notification server 20 in association with the vehicle-specific identification information. The determination result is also preferably transmitted from the measuring instrument 13 to the charge notification server 20 periodically, similarly to the second vehicle data.

Further, the vehicle dealer 10 owns an information terminal device 14 for managing the state of the vehicle-mounted battery of the storage vehicle. The information terminal device 14 can receive information on the state of charge of the vehicle-mounted battery of the storage vehicle from the charge notification server 20 and display the received information on a predetermined screen. An example of the information received by the information terminal device 14 from the charge notification server 20 is a “charging request” for notifying that the in-vehicle battery needs to be charged. The operator of the vehicle dealer 10 or the like confirms the charging request displayed on the screen of the information terminal device 14, and appropriately charges the in-vehicle battery of the vehicle on which the charging request is made, thereby avoiding the occurrence of the battery rise in the storage vehicle in advance. Note that the worker or the like of the vehicle dealer 10 may update the information by inputting the completion of charging of the in-vehicle battery to the information terminal device 14, or may further report (upload) the information from the information terminal device 14 to the charge notification server 20.

The charge notification server 20 is a server for collecting various kinds of information from a plurality of vehicles including the stored vehicles of the vehicle dealer 10 and comprehensively managing the states of the plurality of vehicles. The charge notification server 20 of the present embodiment manages at least the state of charge of the in-vehicle battery as the state of the vehicle.

The charge notification server 20 includes a function of receiving the first vehicle data including the battery SOC from the sensor-mounted vehicle 11 included in the vehicle dealer 10 and receiving the second vehicle data from the sensor-non-mounted vehicle 12 (first receiving unit), a function of receiving the determination result as information regarding the state of charge of the battery from the measuring instrument 13 (second receiving unit), a function of converting the determination result received from the measuring instrument 13 into a battery SOC (conversion unit), a function of determining whether or not charging of the in-vehicle battery is necessary based on the received or converted battery SOC (determination unit), and a function of transmitting a charging request of the in-vehicle battery to the vehicle dealer 10 that stores the vehicle when it is determined that charging of the in-vehicle battery is necessary (transmission unit).

Details of the respective functions of the charge notification server 20 will be described later.

### Control

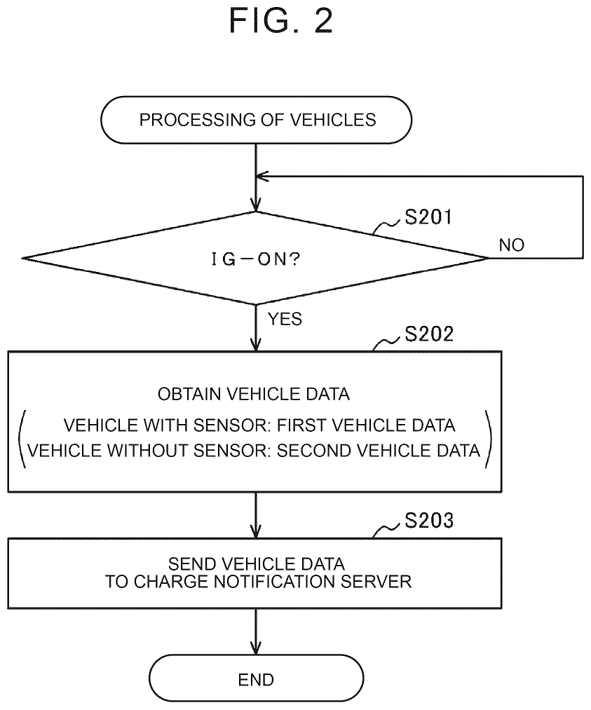

Next, with further reference to FIGS. 2 to 5, the control performed by each configuration of the vehicle management system 1 including the charge notification server 20 according to the present embodiment will be described.

### 1 Processing of Vehicle (FIG. 2)

FIG. 2 is a flowchart illustrating a process executed in a vehicle (the sensor-mounted vehicle 11 and the sensor-non-mounted vehicle 12) stored by the vehicle dealer 10. The processing illustrated in FIG. 2 is executed individually for each vehicle.

### S201

The vehicle determines whether the ignition switch is turned on (IG-ON condition). When the ignition switch of the vehicle is turned on (S201, Yes), the process proceeds to S202.

### S202

The vehicle acquires vehicle data. When the vehicle is the sensor-mounted vehicle 11, the first vehicle data including the battery SOC, the dark current integrated value, and the number of parking days is acquired. When the vehicle is the sensor-non-mounted vehicle 12, the second vehicle data including the information on the number of parking days is acquired. The dark current integrated value and the number of parking days acquired as the first vehicle data may be a difference value from the previous first vehicle data or may be a previous cumulative value. When the vehicle data (first or second) is acquired by the vehicle, the process proceeds to S203.

### S203

The vehicle transmits the acquired vehicle data (first or second) to the charge notification server 20. When the transmission of the vehicle data is completed, the processing in the vehicle is completed.

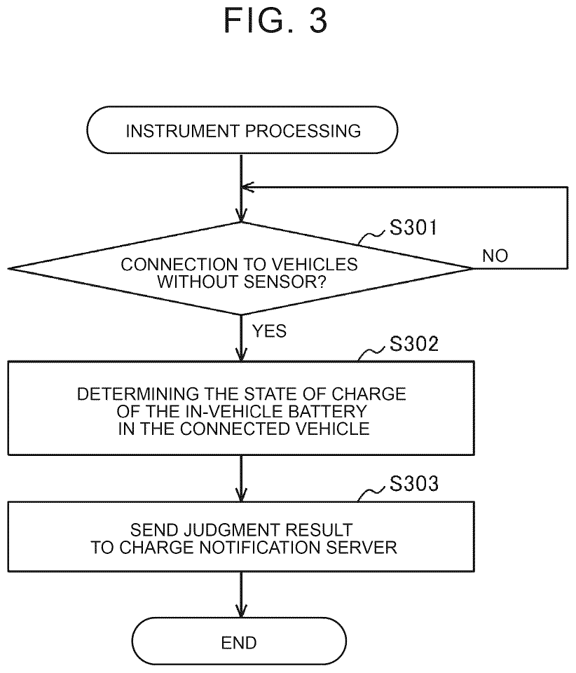

### 2 Processing of Measuring Instruments (FIG. 3)

FIG. 3 is a flowchart illustrating a process executed by the measuring instrument 13 owned by the vehicle dealer 10. The processing illustrated in FIG. 3 may be performed in parallel with the transmission processing of the second vehicle data by the sensor-non-mounted vehicle 12, or may be performed in response to a communication from the charge notification server 20 that has received the second vehicle data.

### S301

The measuring instrument 13 determines whether or not the own instrument is connected to the sensor-non-mounted vehicle 12. Then, when the measuring instrument 13 is connected to the sensor-non-mounted vehicle 12 (S301, Yes), the process proceeds to S302.

### S302

The measuring instrument 13 determines the state of charge of the in-vehicle battery in the sensor-non-mounted vehicle 12 (hereinafter referred to as “connected vehicle”) as the connection destination. This determination is performed based on a voltage, a current, and the like of the in-vehicle battery, and as an example, a result that “the state of the in-vehicle battery is sufficiently charged and good” can be output. Whether or not the state of charge of the in-vehicle battery is good is determined based on a determination condition or the like incorporated in advance in the measuring instrument 13. When the measuring instrument 13 determines the state of charge of the in-vehicle battery in the connected vehicle, the process proceeds to S303.

### S303

The measuring instrument 13 transmits the determination result regarding the state of charge of the in-vehicle battery in the connected vehicle to the charge notification server 20. When the transmission of the determination result is completed, the processing in the measuring instrument 13 is completed.

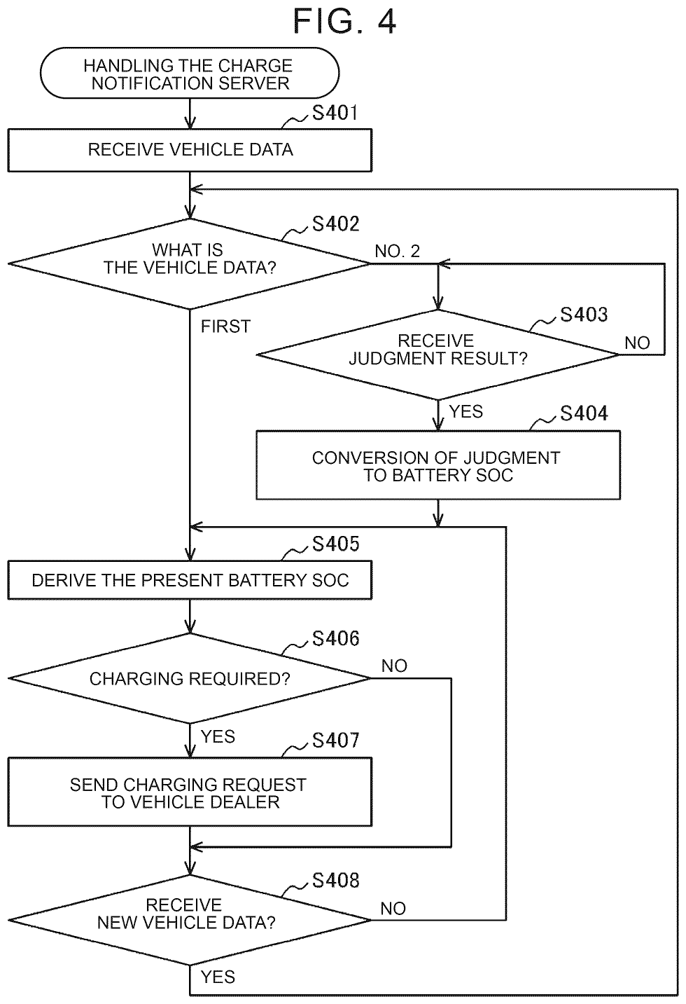

### 3 Charge Notification Server Processing (FIG. 4)

FIG. 4 is a flowchart illustrating a process executed in the charge notification server 20. The processing illustrated in FIG. 4 is executed individually for each vehicle data received from the vehicle.

### S401

The charge notification server 20 receives the vehicle data (the first vehicle data or the second vehicle data) from the vehicle (the sensor-mounted vehicle 11 or the sensor-non-mounted vehicle 12). When the charge notification server 20 receives the vehicle data, the process proceeds to S402.

### S402

The charge notification server 20 determines whether the received vehicle data is the first vehicle data or the second vehicle data. This determination can be made by checking whether or not information of the battery SOC is included in the vehicle data, or by checking identification information unique to the vehicle. When the vehicle data received by the charge notification server 20 is the first vehicle data (S402, first), the process proceeds to S405. On the other hand, when the vehicle data received by the charge notification server 20 is the second vehicle data (S402, second), the process proceeds to S403.

### S403

In the charge notification server 20, the received vehicle data is the second vehicle data. Therefore, the charge notification server 20 determines whether or not a determination result regarding the state of charge of the vehicle-mounted battery of the target vehicle has been received from the measuring instrument 13 connected to the target vehicle (the sensor-non-mounted vehicle 12) that is the transmission source of the second vehicle data. Then, when the charge notification server 20 receives the determination result regarding the state of charge of the vehicle-mounted battery of the target vehicle from the measuring instrument 13 (S403, Yes), the process proceeds to S404.

### S404

The charge notification server 20 converts the determination result received from the measuring instrument 13 into a battery SOC of the in-vehicle battery of the target vehicle. The conversion method is not particularly limited. However, for example, when the state of charge of the in-vehicle battery is determined to be “excellent”, the state is converted into “battery SOC=90%”. In addition, when the state of charge of the in-vehicle battery is determined to be “good”, a method of converting the state of charge into “battery SOC=75%” can be exemplified. In addition, the conversion of the battery SOC may be performed not on the basis of the actual standard design value of the in-vehicle battery, but on the basis of a value having margins somewhat on the safety side with respect to the standard design value. When the determination is converted into the battery SOC by the charge notification server 20, the process proceeds to S405.

### S405

The charge notification server 20 derives the battery SOC of the present in-vehicle battery. Specifically, when the vehicle data is the first vehicle data, the current battery SOC is derived by subtracting the power storage rate of the in-vehicle battery that decreases during parking from the reception date of the first vehicle data to the present day (at the time of derivation) with reference to the battery SOC included in the first vehicle data. The power storage rate that decreases during parking of the sensor-mounted vehicle 11 can be estimated from the dark current integrated value included in the first vehicle data and the number of parking days. Further, when the vehicle data is the second vehicle data, the current battery SOC is derived by subtracting the storage rate of the in-vehicle battery that decreases during parking from the reception date of the second vehicle data to the present day (at the time of derivation) with reference to the battery SOC converted by the above S404. The power storage rate that decreases during parking of the sensor-non-mounted vehicle 12 can be estimated based on the number of parking days included in the second vehicle data and the average dark current value per predetermined parking day. The average dark current value per parking day is preferably set so that the battery SOC derived by considering the design-worst-case value for each vehicle type is lower than the actual battery SOC. When the battery SOC of the present on-vehicle battery is derived by the charge notification server 20, the process proceeds to S406.

### S406

The charge notification server 20 determines whether or not the in-vehicle battery needs to be charged based on the present battery SOC derived in the above S405. This determination is typically made by comparing the battery SOC to predetermined thresholds. The thresholds are predetermined SOC values that are set based on the capacity of the in-vehicle battery, the dark current value, and the like. The thresholds are preferably set to a SOC that has a margin to battery rise, rather than a SOC that is at risk of battery rise immediately. When the charge notification server 20 determines that the in-vehicle battery needs to be charged (S406, Yes), the process proceeds to S407. On the other hand, when the charge notification server 20 determines that charging of the in-vehicle battery is not required (S406, No), the process proceeds to S408.

### S407

The charge notification server 20 transmits, to the vehicle dealer 10, a charging request for notifying a timing at which the in-vehicle battery needs to be charged. The charging request may be an immediate charging request, or may be a request having a time width (for example, charging is required within two days). This temporal width can be arbitrarily set based on the dark current value during parking. When the charge notification server 20 transmits the charging request of the in-vehicle battery to the vehicle dealer 10, the process proceeds to S408.

### S408

The charge notification server 20 determines whether or not new vehicle data (first vehicle data or second vehicle data) has been received from the vehicle (the sensor-mounted vehicle 11 or the sensor-non-mounted vehicle 12) from which the battery SOC of the present on-vehicle battery is derived. If it is determined by the charge notification server 20 that new vehicle data has been received (S408, Yes), the process proceeds to S402, and the battery SOC of the present on-vehicle battery is re-derived based on the newly received vehicle data. On the other hand, when the charge notification server 20 determines that new vehicle data has not been received (S408, No), the process proceeds to S405, and the battery SOC of the present on-vehicle battery is updated based on the received vehicle data.

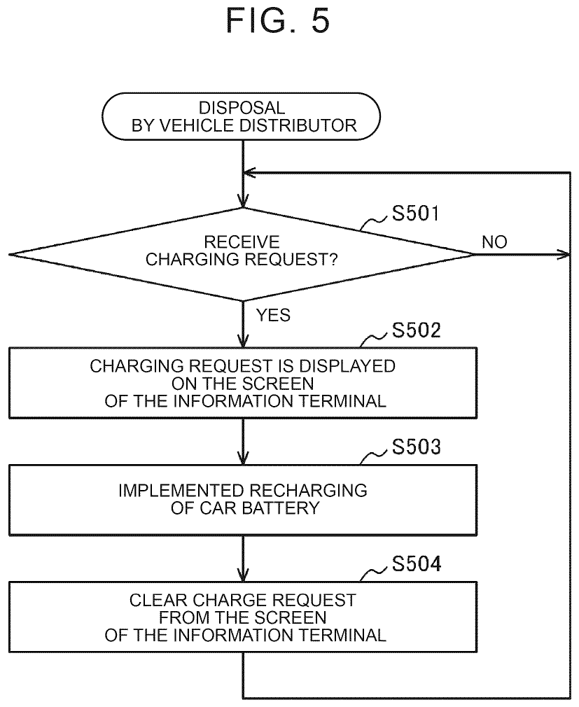

### 4 Vehicle dealer processing (FIG. 5)

FIG. 5 is a flowchart illustrating a process executed in the information terminal device 14 of the vehicle dealer 10. The processing illustrated in FIG. 5 is always performed while the information terminal device 14 is in operation.

### S501

The information terminal device 14 of the vehicle dealer 10 determines whether a charging request has been received from the charge notification server 20. When the charge request is received by the information terminal device 14, the process proceeds to S502.

### S502

The information terminal device 14 of the vehicle dealer 10 displays the received charging request on the screen of the information terminal device 14. The form of the screen display is not particularly limited except that the charging request is displayed in association with vehicle-specific identification information. When the charge request is displayed on the display by the information terminal device 14, the process proceeds to S503.

### S503

A worker or the like of the vehicle dealer 10 performs the charging operation of the vehicle-mounted battery of the corresponding vehicle based on the charging request displayed on the screen of the information terminal device 14. This charging operation may be performed up to a full charge (SOC=100%) or up to a predetermined SOC (for example, 80%) considering the life of the in-vehicle battery. When the vehicle-mounted battery of the vehicle is charged by the worker of the vehicle dealer 10 or the like, the process proceeds to S504.

### S504

When the charging operation of the in-vehicle battery of the vehicle is completed, the worker or the like of the vehicle dealer 10 deletes the charging request displayed on the screen of the information terminal device 14 by inputting the charging completion information to the information terminal device 14. If the vehicle management system 1 is constructed as described above, it is possible to suppress the vehicle-mounted battery being charged. In the case where the corresponding vehicle is the sensor-non-mounted vehicle 12, the processing (FIG. 3) by the measuring instrument 13 may be performed after the charging operation of the vehicle-mounted battery is completed. When an operator of the vehicle dealer 10 or the like deletes a charge request displayed on the display of the information terminal device 14, the process proceeds to S501.

### Operations and Effects

As described above, the charge notification server 20 according to the embodiment of the present disclosure receives the second vehicle data that does not include the battery SOC from the vehicle with respect to the sensor-non-mounted vehicle 12. In addition, the charge notification server 20 according to an embodiment of the present disclosure includes a configuration that receives a determination result regarding the state of charge of the battery from the measuring instrument 13 and converts the determination result into a battery SOC.

With this configuration, in the same vehicle management system 1 as the sensor-mounted vehicle 11 that can receive the first vehicle data including the battery SOC, the sensor-non-mounted vehicle 12 can determine whether or not the battery needs to be charged based on the battery SOC, and when it is determined that the battery needs to be charged, a battery charge request can be transmitted to the vehicle dealer 10.

With this charging request, the vehicle dealer 10 can easily confirm the vehicle in which the battery needs to be charged. Further, the vehicle dealer 10 can suppress the battery being uncharged by continuing to display the charging request on the screen of the information terminal device 14 until the charging operation of the battery is performed.

Although an embodiment of the present disclosure has been described above, the present disclosure can be regarded as a method executed by a charge notification server including not only a charge notification server but also a processor and a memory, a program for executing the method, a computer-readable non-transitory storage medium storing a program, or a system including a charge notification server, a vehicle dealer, and the like.

The charge notification server of the present disclosure can be used when it is desired to notify a vehicle dealer or the like of the necessity of charging the in-vehicle battery of the inventory vehicle.

What is claimed is:

1. A charge notification server that makes a notification about a battery mounted on a vehicle, the charge notification server comprising:
a first receiving unit that receives, from the vehicle, either one of first vehicle data including a battery state of charge as a power storage rate of the battery and second vehicle data not including the battery state of charge;
a second receiving unit that receives information about a charge state of the battery from an external device connected to the vehicle when the first receiving unit receives the second vehicle data;
a conversion unit that converts information about a charge state of the battery into the battery state of charge;
a determination unit that determines whether the battery needs to be charged based on the battery state of charge; and
a transmission unit that transmits a request to charge the battery when the determination unit determines that the battery needs to be charged.

2. The charge notification server according to claim 1, wherein the first receiving unit receives the first vehicle data from a vehicle equipped with a sensor that is able to acquire the battery state of charge, and receives the second vehicle data from a vehicle not equipped with the sensor.

3. The charge notification server according to claim 1, wherein the determination unit determines whether the battery needs to be charged based on the battery state of charge received by the first receiving unit or the battery state of charge resulting from conversion by the conversion unit and an average dark current value per parking day during a parking period of the vehicle.

4. The charge notification server according to claim 1, wherein the transmission unit transmits a request to charge the battery to a vehicle dealer that stores the vehicle.
